(19) United States
(12) Patent Application Publication
(10) Pub. No.: US 2008/0308294 A1
(43) Pub. Date: Dec. 18, 2008

(54) Swizzled twisted pair cable for simultaneous skew and crosstalk minimization

(76) Inventor: Rajendran Nair, Gilbert, AZ (US)

Correspondence Address: Rajendran Nair, ComLSI Inc., 3838 E Encinas Ave, Gilbert, AZ, 85234, US

(21) Appl. No.: 11/818,127

(22) Filed: Jun. 14, 2007

(51) Int. Cl. H01B 11/02

(52) U.S. Cl. 174/113 R

(57) ABSTRACT

A novel varied twist-rate wire pair and cable architecture are disclosed. The invention implements variable twist rate along twisted wire pair length, providing approximately equivalent physical and electrical length values for segments of such twisted wire pair, and consequently, low delay skew, and substantially minimized inter-pair crosstalk due to reduction of twist-rate correlation along the length of a UTP cable employing the invention. Due to the elimination of the need for shielding, the invention method yields flexible, low-cost cables that may be employed for extremely high data throughput applications such as HDMI. Minimized inter-pair skew also eliminates the need for channel re-alignment at the end of long cable runs. Through these benefits, the invention twisted pair and cable facilitates continued enhancements in multi-media electronics while containing cost for high-performance interconnect.

### RELATED DOCUMENTS

None.

### TECHNICAL FIELD OF THE INVENTION

Embodiments of the invention relate to electronic wiring and cabling employed to conduct signals from point to point. Such embodiments fall under the category of wired interconnect components.

### BACKGROUND & PRIOR ART

Twisted wire pairs and cables employing multiple twisted pairs are ubiquitous in the electronics industry. While twisted wire pairs are excellent from the standpoint of reduced EMI and reasonable consistency of impedance along the length of the wire pair, they are prone to other issues such as crosstalk and inter-pair skew. Prior art has attempted to minimize inter-pair skew, the difference in delay between signals transmitted on two adjacent signal pathways, by ensuring that both (or all) twisted wire pairs are constructed identically, with exactly the same twist rate. Whereas this ensures that the total physical length and the corresponding effective electrical length of the twisted wire pairs are the same or nearly the same, a side-effect is a dramatic increase in crosstalk between adjacent twisted wire pairs because of the very uniformity and consistency of twist that lends low skew. Again, prior art has addressed the increased crosstalk by adding shielding jackets around twisted wire pairs. While shielding helps to minimize crosstalk, it substantially impacts the impedance of the twisted wire pair, and leads to the necessity for thicker insulation for the wires of the twisted wire pair. The overall effect is a very substantial increase in the volume and mass of the wire pair per unit length, leading to bulky, physically inflexible and expensive cables.

Prior art twisted wire pair as well as standardized cables such as Cat-5e, Cat-6 (different categories specified by the Electronics/Telecommunications Industry Associations) addresses such concerns of electromagnetic coupling or crosstalk without shielding as well. A wire pair consists of two individual wires coupled strongly and placed close to each other providing a means for ‘differential signaling’, a technique whereby a signal and its complement are transmitted simultaneously and the corresponding symbol recognized as the difference between the two electrical quantities received. Any distant-source noise that couples electro-magnetically into this wire pair couples in very much the same manner into both wires, thereby retaining the difference signal the same, and causing no significant degradation in signal integrity as long as the receiver differential amplifier is capable of rejecting this ‘common-mode’ noise. But a wire pair lying adjacent to another wire pair may not see such a benefit, such as in a flat-tape cable where signal wires as arranged in a bonded fashion adjacent to each other. This problem is effectively addressed by twisting the wires of the wire pair around each other. Over a sufficient length, because of the twist, the coupled noise from any adjacent signal wire sums out to be the same on both individual wires of a twisted wire pair, thus again rendering such noise ‘common-mode’. But this effect does not help when two twisted wire pairs, adjacent to each other in a cable, are twisted identically, leading to physical proximity of wires between the wire pair akin to that which exists when wires are not twisted. To address this issue, prior art standard cables such as Cat-5e also offset the twists of wire pairs with respect to each other, starting with a low twist rate for one wire pair and tightening the twist rate for other included wire pairs in the cable assembly. Because the twist rates are different, the probability of physical proximity between two wire pairs akin to that which may exist in untwisted wire pairs is greatly minimized. The unfortunate consequence of such a design is that there is significant and unavoidable skew between the wire pairs of the cable.

Additionally, twisted wire pairs are also prone to impedance discontinuities that arise due to the physical separation of the wires of the wire pair that may arise due to assembly errors. As the frequency of data transmission through wire pairs increases, these impedance discontinuities become more significant and impact signal integrity. Attempts to correct such problems include very tight twisting as is done in improved cabling solutions in the industry [Ref. 5]. Such designs further increase effective electrical lengths of the twisted wire pairs, potentially increasing inter-pair (between wire pairs) skew and thereby increasing synchronization challenges between signals flowing in wire pairs within a cable assembly. Inter-pair skew is a problem usually addressed by realignment circuits in receiver systems. Values of inter-pair skew in Cat-5e cables resulting from twist offset are typically more than 1 nS per 10 meters of length.

A need therefore exists for improving cable architecture and the simultaneous minimization of inter-pair skew and crosstalk in a cost-effective manner.

As the definition and quality of 2-D and potentially, 3-D images and audio in multimedia transmission increases, there is a need for significantly higher data rates and correspondingly high frequencies of operation of such links as defined in the High Definition Multimedia Interface (HDMI) specification [1]. In order to provide such high-throughput data flow within homes and small establishments, there also exists a need to develop cables that are flexible and therefore easily installed and used without the concerns associated with thick, inflexible cables. Thus wire-pair shielding that leads to a need for thicker wires is not a preferred technology direction for high-performance cables.

### INVENTION SUMMARY

The invention implements a method for simultaneous crosstalk and skew minimization through the variation of twist rate along lengths of twisted wire pairs. Wire pairs are twisted with twist rates chosen from a finite set of twist rates, feasible for the wire size, and for finite lengths, chosen from a set of lengths, such that the twist rate or twist rate and length corresponding to the twist rate are changed in a random fashion as the wire pair is twisted. In one embodiment, the algorithm that changes the twist rate and twist length randomly does so in order to ensure that any segment of the twisted wire pair of length to which the algorithm corresponds demonstrates approximately the same signal delay (or effective physical length of each wire of the pair) as any other segment. Additionally, the randomness in the choice of twist rate and twist length is designed to ensure that any segment of such twisted wire pair laid adjacent to any other segment does not share the same twist rate over a significant fraction of the twisted wire pair segment length. Such ‘swizzling’ or mixing of the twist rate and length leads to the crosstalk minimization benefit associated with varied twist rates for adjacent wire pairs while ensuring that both wire pairs have approximately the same physical length or electrical delay. Swizzled twisted wire pairs may also be shielded for additional cross-talk minimization. A cable consisting of multiple swizzled twisted wire pairs may also be shielded in its external jacket that maintains cable structure. Through these enhancements, the invention cable architecture minimizes inter-pair skew while simultaneously minimizing crosstalk without a necessity for shielding.

### BRIEF DESCRIPTION OF THE FIGURES

FIG. 1 illustrates typical prior category 5 (a) and enhanced data cables (b) with twisted wire pairs of varying twist rates placed adjacent to each other.

FIG. 2 is an illustration of an embodiment of the invention method in a cable.

FIG. 3 is an illustration of an alternate embodiment of the invention method in a cable, wherein twist rate is varied by splicing together two cables to achieve the necessary cable length with twisted pairs of equivalent physical length.

FIG. 4 illustrates a preferred method for bonding wires of the wire pair.

FIG. 5 illustrates a segment of a 4-swizzled-wire-pair bundle that may be repeated indefinitely while providing minimal inter-pair skew and crosstalk.

### DETAILED DESCRIPTION

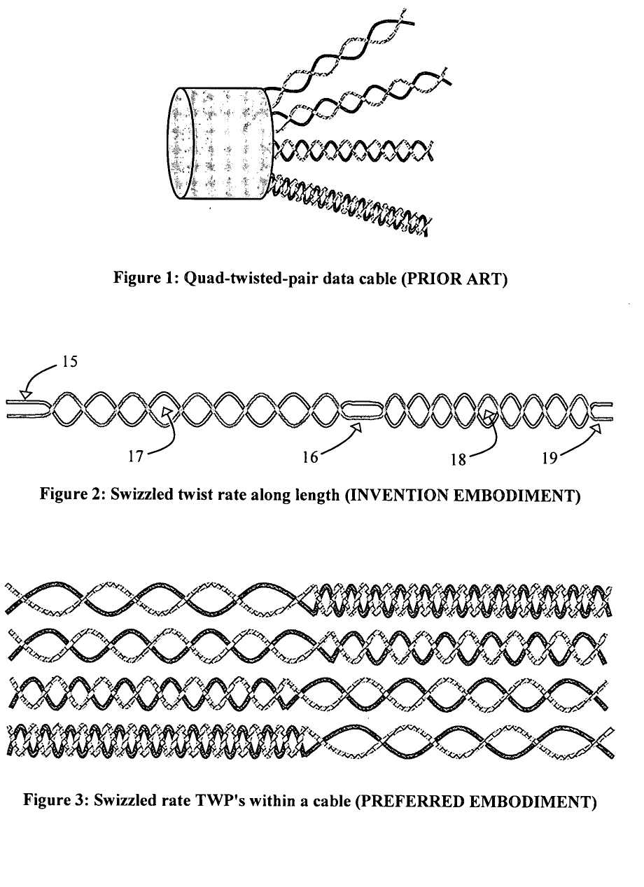

Prior art unshielded twisted wire pair (TWP) cables are illustrated in FIGS. 1 (a) and (b). A principal aspect of TWP's is the twist introduced into the wire pair along its length. This twist entwines both wires with each other and has significant advantages for the wire pair as well as the cable assembly. Not only does the twist cancel emissions through magnetic cancellation from the wire pair when a signal is transmitted ‘differentially’ through the wire pair, it also renders any noise introduced into the wires ‘common-mode’, or common to both wires. Additionally, by varying the rate of twist between wire pairs inside a cable assembly, noise coupled from one wire pair into an adjacent one is also diminished substantially provided the cable is of sufficient length. With these important advantages, twisted wire pairs may be used in unshielded fashion; Category 5 and 6 cables as defined by the TIA/EIA standards employ both unshielded twisted pair (UTP) and shielded twisted pair (STP) architectures. FIG. 1 (a) displays a prior art cable conforming with the category 5 specification, while FIG. 1 (b) displays a prior art cable with improved crosstalk (through very tight twisting) employed for data rates as high as 10 giga (billion) bits per second (Gbps).

Prior art wire pair twist and cable design introduces a significant disadvantage in the variation of the effective lengths between wire pairs. Twist rates for TWP's are made different to improve crosstalk between TWP's, and this leads to substantial variation in effective lengths of the TWP's. A significant disparity in the effective length of one wire pair with respect to others leads to what is called ‘inter-pair-skew’ that leads to limitations in maximum cable run lengths as well as the need for sophisticated re-alignment integrated circuitry. Prior art attempts at eliminating inter-pair skew include assembling cables out of well-shielded twisted wire pairs that have exactly the same twist rate, or shielded twin-axial or co-axial cable assemblies. Such cable designs are bulky and expensive, and therefore undesirable in conjunction with consumer electronics components such as multi-media devices that see steady erosion in sales prices.

To address the problem of crosstalk and the need for low delay skew simultaneously, the invention proposes varied twist rate or twist rates along the length of TWP's. This goes directly against prior art design and manufacturing practices for TWP's and introduces some challenges in the manufacturing process, which, along with possible solutions, are described in further paragraphs. By varying the twist rate along the length of a TWP, it is possible to both equalize the lengths of all TWP's in a cable while retaining the crosstalk benefit of incongruent twist rates along the length of the cable. As an example embodiment, consider a prior art unshielded twisted pair (UTP) category 5e (Cat-5e) cable length of 2.5 meters. Because of the varied twist rate between the four TWP's in this cable, there exists a deterministic (defined by design/manufacturing variations) delay skew or inter-pair skew between the TWP's. Say the delay numbers for the TWP's are A-tightest twist rate, B-next lower twist rate, C-second-from-the-last twist rate and D-loosest twist rate TWP. Now if an identical Cat-5e cable of 2.5 m were to be spliced to the first, such that the tightest twist rate TWP of the first cable is joined to the loosest twist rate TWP of the second cable, the second tightest or next lower twist rate TWP of the first cable is joined to the second-from-the-last twist rate TWP of the second cable and so on, we obtain a 5 meter cable with delays in the TWP's being (A+D), (B+C), (C+B) and (D+A). It is obvious to one skilled in the art that if the twist rates are designed such that (A+D)=(B+C), all the TWP's of the jointed 5 meter Cat-5e cable will display exactly the same signal delay values, or negligible inter-pair skew. Simultaneously, the crosstalk benefits of varied twist rate along the length of the cable are retained as the same per unit length as in the original 2.5 m Cat-5e cable. In this embodiment of the invention, each TWP sees a single variation in the twist rate at the 2.5 m mark along the length of the 5 m cable, or at the midpoint of any length of this ‘swizzled’ twisted wire pair (SZTP) cable.

Illustrations of the embodiment described above are shown in FIGS. 2 and 3. Whereas the figures do not clearly show that the wires are twisted around each other, it is to be understood that the invention as well as this specification deals only with wires twisted around each other in a double helix form, and that the figures are meant to indicate such twist. Varying twist rates are shown as variations in the frequency of cross-over of wires in the figures.

With reference to FIG. 2, 17 points to a particular twist rate sub-length joined to another higher twist rate sub-length 18, joined at junction 16. 15 and 19 are the origin and the endpoint of this swizzled twisted wire pair embodiment. In this illustration (which is not drawn to scale), signal delay from 15 to 16 is different from the delay from 16 to 19, since both these segments are of approximately the same length and have different twist rates.

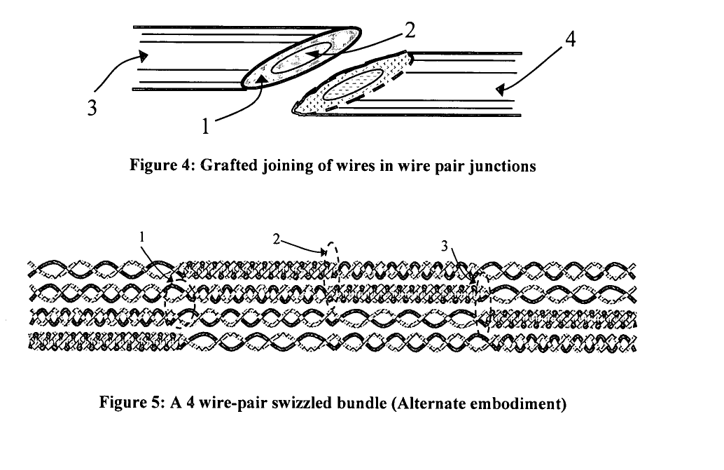

The junction at 16 in FIG. 2 may be constructed through a joining process akin to grafting as illustrated in FIG. 4. With reference to FIGS. 4, 3 and 4 are the wires to be grafted and joined, 1 is the insulation material and 2 the conductor surface. An angular cut and soldered attachment of the conductor may be accomplished through transient high-current flow through the junction. Thermal energy generated in such a process assists in fusing the insulation material surfaces as well. While such a joining process employed on both wire pathways of the swizzled twisted pair provides a seamless joint without an impedance discontinuity, the joint will be substantially weaker than a continuous uncut wire, and may therefore require additional mechanical support to prevent breakage in bending or pulling. Such mechanical support may be provided by additional plastic molding in the joint region, an inelastic, unbroken cord running the full length of the cable, or mechanical fasteners that hold the joined sections of varied twist rate together after bonding.

With reference to FIG. 3, that illustrates an embodiment of a 4 swizzled-wire-pair bundle, one skilled in the at will recognize that the benefit of crosstalk minimization through twist variation is maintained throughout the length of the cable, while all of the swizzled wire pairs can be designed to demonstrate approximately the same signal delay.

The invention embodiment described above deals with jointed twisted wire pairs of different twist rates. While this derives the benefits of the invention method, it may be undesirable as a manufacturing process due to the presence of a joint in the cable, that while being an additional manufacturing step, may also introduce impedance discontinuities that may impact very high speed data throughput.

An alternate embodiment of the invention employs random variations of the twist rate along the TWP length. Such a design is truly ‘swizzled’, or is an embodiment where the twist rate is ‘agitated’ along the length of the wire pair. A SET of a number of TWIST RATES are chosen, such that the twist rates are sufficient to maintain the two wires in close proximity to each other despite bends in the TWP, and such that any small length of wire pair of one twist rate laid adjacent to a length of wire pair of another twist rate effectively cancels out or substantially minimizes crosstalk. When this alternate embodiment of the swizzled twisted wire pair (SZTP) is made, the twist rate is varied, chosen at random or pseudo-random from the SET of TWIST RATES, such that the twist rate changes within wire pair length that is a small fraction of the desired length of cables assembled from this wire pair roll. For example, if it is desired that cables of length 1 meter be made using multiple segments of SZTP, the twist rate is varied at least every 10 centimeters. The probability of selection of any particular twist rate out of the SET is made the same as the probability for any other twist rate. Because of the random variation of the twist rates along the length of the SZTP, and equal probability for all twist rates, any reasonable cable-length of wire cut out from the SZTP roll will contain approximately the same content of different twist rates, thereby ensuring that the effective physical length of wire of the cable-length will be the same as any other such cable-length cut out from the SZTP roll. Additionally, since the twist rates are chosen at random, the correlation in twist rate between any two cable-lengths of SZTP wire, or the fraction of the cable-length for which the twist rate is identical when these cable-lengths are placed adjacent to each other can be made small. In other words, two cable-lengths of SZTP will not only exhibit almost the same physical length of wire and electrical signal delay, but also behave as if the twist rate is different along most of the cable-length, thus ensuring very low crosstalk in unshielded cable architecture.

FIG. 5 illustrates, in simplified form, an embodiment of a 4 swizzled-wire-pair bundle where the twist rate is varied in a manner such that no adjacent sub-lengths have the same twist rates. With reference to FIG. 5, regions marked 1, 2 and 3 are overlaps of identical twist rates, which one skilled in the art may appreciate as being a very small fraction of the total length of the cable. It can also be seen that the arrangement of FIG. 5 may be extended indefinitely, providing the benefit of equalized delay through all twisted wire pairs while retaining the low crosstalk benefit of a varied twist rate. The algorithm that chooses the twist rates in sequence may therefore not be entirely random as illustrated by this embodiment.

One skilled in the art can also appreciate that to ensure a degree of certainty in terms of effective physical length, the sub-length for which a certain twist rate is maintained may be correlated to the twist rate itself. In other words, for a tighter twist, one can control the sub-length to be small, and for a looser twist rate, the sub-length may be made proportionately larger. This will ensure that any choice of twist rate, made at random, will result in a constant increase to the effective physical length of the SZTP. In other words, a SET of SUB-LENGTHS may be mapped one-to-one to the SET of TWIST RATES during manufacture. Alternately, the set of sub-lengths may only contain one value used for all the twist rates.

Through the use of a SET of SUB-LENGTHS, one skilled in the art can also appreciate that another dimension of randomness may be introduced into swizzling. If SUB-LENGTHS are also chosen at random, instead of being chosen in accordance with the chosen twist rate from the SET of TWIST RATES, one may derive a further benefit in the form of a reduction of correlation between any two cable-lengths of wire from the SZTP roll. Whereas this may provide further crosstalk benefit, it may also widen the DELAY SKEW or inter-pair skew distribution. A correlated (mapped) swizzling algorithm that matches a twist rate with a twist sub-length will, on the other hand, display an extremely narrow delay skew distribution, while displaying most of the crosstalk benefits of the invention.

While the architecture and design of machines that implement a swizzled twisting algorithm are beyond the scope of this disclosure and specification, a discussion on the modifications necessary in order to accomplish swizzling is appropriate. As indicated previously in this specification, changing the twist rate dynamically as wires are twisted to form a wire pair can be difficult due to the mechanical momentum and inertia of the machines employed for this purpose. In its simplest form, a machine that twists wires in a double helix may use a spinning disk with tensed wires fed through holes situated at matched radial distances from the axis of rotation, while the twisted wire is rolled up by another spinning mechanism. Such machines are best calibrated to run at a constant rate specifically because of the inertia of the spinning systems. The rate at which the twisting disk and all associated mass rotate may be controlled by a motor that in of itself may be incapable of changing this rate rapidly in order to transition to another twist rate. This change may be facilitated by any number of mechanisms, such as mass that can be repositioned radially (at different distances from the spin axis) through electronically controlled movement away from, or towards the spin axis, or changes in spin speed limiting fluid viscosity that may be controlled electronically, or rapid changes in mass by the expulsion or injection of fluid into the spinning system. There will be a delay in transitioning from one spin rate to another, thus making the change in twist rate continuous. Recalibration and machine modifications may be necessary.

Alternately, swizzling may be accomplished by changing the rate of ‘pull’ on the wire pair as it is rolled after being twisted, which may be controlled primarily by an electronic motor and gear mechanism, and may pose less of a challenge as compared with changing the spin-speed of the twisting disk. Again, machine modifications and recalibration may be necessary. The inventor believes this to be a preferred modification for best implementation of the invention.

Although specific embodiments are illustrated and described herein, any method, process or component arrangement configured to achieve the same purposes and advantages may be substituted in place of the specific embodiments disclosed. This disclosure is intended to cover any and all adaptations or variations of the embodiments of the invention provided herein. All the descriptions provided in the specification have been made in an illustrative sense and should in no manner be interpreted in any restrictive sense. The scope, of various embodiments of the invention whether described or not, includes any other applications in which the structures, concepts and methods of the invention may be applied. The scope of the various embodiments of the invention should therefore be determined with reference to the appended claims, along with the full range of equivalents to which such claims are entitled. Similarly, the abstract of this disclosure, provided in compliance with 37 CFR §1.72(b), is submitted with the understanding that it will not be interpreted to be limiting the scope or meaning of the claims made herein. While various concepts and methods of the invention are grouped together into a single ‘best-mode’ implementation in the detailed description, it should be appreciated that inventive subject matter lies in less than all features of any disclosed embodiment, and as the claims incorporated herein indicate, each claim is to viewed as standing on its own as a preferred embodiment of the invention.

What is claimed is:

1. A cable, with swizzled twisted wire pairs, comprising:
Multiple twisted wire pairs of varied twist rates;
where the twisted wire pairs of the cable are cut, approximately at the cable mid point, and the twisted wire pairs are swizzled and joined such that the twisted wire pair with the lowest twist rate is physically and electrically bonded to the twisted wire pair with the highest twist rate, and the twisted wire pair of the second lowest twist rate is bonded to the twisted wire pair of the second highest twist rate, and so on until all twisted wire pairs are bonded at the joint.

2. The cable of claim 1 where the twisted wire pairs are grafted together while maintaining the necessary proximity of the wires to each other to minimize impedance discontinuities.

3. The cable of claim 1 where the twist rates are chosen such that the electrical signal propagation delay in a unit length of a twisted wire pair of a given twist rate differs from the propagation delay through a unit length of twisted wire pair of the next higher or lower twist rate by a constant amount.

4. The cable of claim 1, with twisted wire pairs connected to each other through bilaterally symmetric passive equalizing or resonant filter circuits tuned to compensate for high-frequency losses and wave dispersion along the full cable length.

5. The cable of claim 1 employed for high definition multimedia and other high throughput data, signal and information transmission applications.

6. A cable, with randomly swizzled twisted wire pairs, comprising:
Multiple twisted wire pairs, each with multiple sub-lengths of randomly varied twist rate;
Where the twist rates are chosen for all twisted wire pairs from the same finite set of twist rates, with the mean and the median twist rate being the same for all twisted wire pairs;
And where the probability of selection of any particular twist rate is the same as that of any other twist rate in the set of twist rates;
And further, where the sub-lengths are chosen from a finite set of sub-lengths, that is one-to-one mapped with the finite set of twist rates, such that any twist rate combined with the sub-length mapped to it results in approximately the same physical wire length used.

7. The cable of claim 6 where the maximum sub-length in the set of sub-lengths is at least an order of magnitude smaller than the minimum cable length desired.

8. The cable of claim 6 where the set of sub-lengths contains a single value.

9. The cable of claim 6, where the twist rates of the set of twist rates are chosen such that crosstalk from a sub-length of a twisted wire pair of any twist rate of the set to an adjacent sub-length of a twisted wire pair of another twist rate of the set is minimal.

10. The cable of claim 6 employing a pseudo-random algorithm for the sequential selection of twist rates along wire pairs.

11. The cable of claim 6 employed in signal and data transmission applications requiring very low inter-pair skew over lengths greater than 10 meters.

12. The cable of claim 6 employed for high definition multimedia and other high throughput data, signal and information transmission applications.

13. A method for inter-pair skew minimization, comprising:
Twisting a wire pair with twist rates chosen in a random or pseudo-random manner from a set of twist rates in sequences of sub-lengths chosen from a set of sub-lengths, where the probability of selection of any twist rate in the set of twist rates is the same as that of any other twist rate of the set, and where the sub-lengths of the set of sub-lengths are one-to-one mapped to the twist rates of the set of twist rates, such that any twist rate employed for its corresponding sub-length uses approximately the same amount of untwisted wire;
And assembling a cable using multiple segments of such twisted wire pair, where the segment length is at least an order of magnitude greater than the maximum sub-length of the set of sub-lengths employed, such that the mean and median twist rate for any wire pair segment are approximately the same as that for any other in the cable.

14. The method of claim 13 employed to create cables conforming to Cat 5, Cat 5e, Cat 6 and other advanced specifications of the telecommunications and electronics industry associations.

15. The method of claim 13 employed to create cables for high definition multimedia and other high throughput data, signal and information transmission applications.

16. Electronic cables, circuits and systems, and specifically, systems transmitting electronic signals that employ the cable of claim 1 in any embodiment.

17. Electronic cables, circuits and systems, and specifically, systems transmitting electronic signals that employ the cable of claim 6 in any embodiment.

18. Electronic cables and interconnect systems transmitting a plurality of electronic signals at employing the method of claim 13 in any embodiment.
